(19) United States
(12) Patent Application Publication
(10) Pub. No.: US 2025/0023371 A1
(43) Pub. Date: Jan. 16, 2025

(54) PUSHABLE TRANSPORT CART AND PUSHABLE TRANSPORT CART SYSTEM

(71) Applicant: EXPRESSO Deutschland GmbH & Co. KG, Kassel (DE)

(72) Inventors: Claudius Wilhelms, Kassel (DE); Uwe Vellmer, Meinhard (DE); Eduard Kamzin, Vellmar (DE); André Hildmann, Kassel (DE)

(73) Assignee: EXPRESSO Deutschland GmbH & Co. KG, Kassel (DE)

(21) Appl. No.: 18/771,759

(22) Filed: Jul. 12, 2024

(30) Foreign Application Priority Data
Jul. 14, 2023 (DE) 10 2023 118 738.4

(51) Int. Cl. H02J 7/00; B62B 3/14; B62B 5/00

(52) U.S. Cl. CPC H02J 7/0042; B62B 3/1424; B62B 5/0096; H02J 7/00712

(57) ABSTRACT

The invention relates to a pushable transport cart. The pushable transport cart has an electric storage device for supplying electric power to electric and/or electronic devices. To charge the storage device, the pushable transport cart can be connected to a stockage and/or charging station via an electric connecting device, which is integrated into a connecting cord or a safety chain of the pushable transport cart.

### CROSS REFERENCE TO RELATED APPLICATIONS

This application claims priority to co-pending German Patent Application No. DE 10 2023 118 738.4 filed Jul. 14, 2023, the disclosure of which is hereby incorporated herein by reference in its entirety.

### FIELD OF THE INVENTION

The invention preferably relates to a shopping cart, such as that used in stores, grocery stores or shopping centers, or a baggage cart, such as that used in travel centers, for example railroad stations, airports or hotels. In general terms, the invention is used in any pushable transport cart which stands on the floor via rollers, can be pushed manually by a user via a handling device such as a handle or a push bar and on or in which objects such as shopping goods or baggage can be arranged for transport.

Recently, such pushable transport carts have been equipped with electric and/or electronic devices whose operation requires an electric power supply via an electric cable. If the pushable transport cart with the electric or electronic device is to be able to move autonomously without being connected to a cable, the push transport cart must be equipped with an electric storage device that supplies the electronic device with electric power. Such a storage device must always be recharged.

The invention also relates to a pushable transport cart system with several push transport carts and a stockage and/or charging station.

### BACKGROUND OF THE INVENTION

Pushable transport carts, which can be connected to each other in a pushable transport cart system, as well as pushable transport cart systems are known. The publications DE 10 2017 003 243 B4, GB 2 429 318 A and DE 20 2015 008 935 U1 disclose shopping carts with an electronic device, an electric storage device for supplying power to these and with an electric connecting device via which the shopping cart can be connected to other similar shopping carts for transmitting power or signals. The electric connecting device is combined with a mechanical connecting device embodied as a securing chain or plug in such a way that an electric connection is simultaneously established when the shopping carts are mechanically connected.

### SUMMARY OF THE INVENTION

The invention proposes a pushable transport cart and a pushable transport cart system which is improved in particular with regard to
charging and discharging and/or
operational safety and risks to the health of the user and/or
ease of use and/or
availability and/or
visual appearance and/or
compact design and/or
multifunctional use of components and/or
electric charging currents and/or charging voltages and/or
a charge flow management and/or
a voltage level of the charging station and/or the pushable transport cart and/or
a mechanical locking device to prevent rolling away and/or an anti-theft device and/or
motivating the user to return the pushable transport cart to a charging and/or stockage station after use, and/or
fluctuating customer demand with regard to the use of pushable transport carts.

The invention relates to a pushable transport cart, which is in particular a shopping cart or baggage cart pushed manually by a user. In the following, reference is preferably made in part to a shopping cart, whereby the corresponding can then also apply to a baggage cart or any other push transport cart.

The pushable transport cart comprises at least one electric and/or electronic device. To give only a few non-limiting examples, the electric and/or electronic device may be
measurement technology, in particular a sensor (for example a temperature sensor, a sensor for detecting the mass of an object arranged on or in the shopping cart or baggage cart, an acoustic sensor for detecting a surrounding noise or a rolling noise of the pushable transport cart, a scanner for detecting a contour of the product or baggage or for detecting characteristic data of the product or baggage or a marking, in particular a barcode or QR code), and/or
evaluation electronics for the measurement technology and/or
uni- or bidirectional wireless or wired communication devices (e.g. for an update of control logic of an electronic control unit of the pushable transport cart, a transfer of parameters to the pushable transport cart or a transmission of measured or operating variables from the pushable transport cart to other components of the pushable transport cart system or for uni- or bidirectional communication with a portable network-capable electronic device of the user) and/or
locking systems operated by means of an electric actuator for securing the pushable transport cart relative to an adjacent pushable transport cart or relative to a stockage and/or charging station
an electronic control unit and/or
a drive system of the pushable transport cart that supports a pushing force applied by the user.

The pushable transport cart may also have a mechanical connecting device. The push transport cart can be mechanically connected to another pushable transport cart and/or a stockage and/or charging station via the mechanical connecting device. Without this necessarily being the case, the pushable transport cart can be locked in place at a parking location, in particular in the area of the stockage and/or charging station, via the mechanical connecting device, whereby a more or less large locking or securing force can be provided by the mechanical connecting device. For conventional shopping carts, the mechanical connecting device is often embodied as a securing chain of a pushable transport cart, whereby the securing chain then comprises a plug-in tongue at the end, which can be inserted into a corresponding plug socket of an adjacent pushable transport cart. The plug-in tongue can then be secured in the plug socket via a coin-operated lock, which ensures that the pushable transport cart can only be removed by inserting a coin into the coin-operated lock and that the user is required to reconnect the pushable transport cart to another pushable transport cart or the stockage and/or charging station after use in order to retrieve the coin from the coin-operated lock. The mechanical securing device is preferably directly or indirectly attached to a handling device such as a handle or a push rod oriented in the transverse direction of the pushable transport cart, over which the user pushes the pushable transport cart.

In one embodiment, the pushable transport cart comprises (at least) one electric storage device, which is, for example, an electric accumulator, in particular a chemical storage device of any type (in particular lithium-ion storage device, sodium-ion storage device, lead storage device, LiFePo4 storage device) and/or an electric capacitance or supercapacitance. The electric storage device is connected to the at least one electric and/or electronic device in order to supply it with electric power and thus also enable self-sufficient operation of the pushable transport cart.

In one embodiment, the mechanical connecting device can be used multifunctionally. For this purpose, the mechanical connecting device and an electric connecting device are combined, with the electric connecting device preferably being integrated into the mechanical connecting device. The mechanical connecting device and the electric connecting device are configured such that when the mechanical connecting device is mechanically connected to the mechanical connecting device of an adjacent pushable transport cart or the stockage and/or charging station, at least one electric connection is created between the electric connecting device and an electric connecting device of the other pushable transport cart or the stockage and/or charging station. An electric power exchange and/or a signal exchange and/or a data exchange between the two pushable transport carts can then take place via this created electric connection. The electric power exchange can serve to change the status of charge, whereby it is possible that the electric storage device is charged via the electric connection created. However, it is also possible for the electric storage device to be discharged via the electric connection, with the discharged electric power being transferred to the other push transport cart to charge it or to pass it on to another pushable transport cart.

Any signal exchange via the electric connection created can be used to transmit a measurement signal, for example with regard to an operating variable, an exchange of a specific parameter for the pushable transport cart, etc.

Any data exchange via the electric connection can be used, for example, to exchange information about the charging status of the electric storage device or to exchange information about whether another pushable transport cart is connected to the pushable transport cart on a side facing away from the charging station.

In one embodiment, a further electric connecting device is provided at a distance from the electric connecting device and the mechanical connecting device. The electric connecting device and the further electric connecting device form at least one closed circuit.

A further electric connecting device can be provided on the pushable transport cart at a distance from the electric connecting device integrated in the mechanical connecting device. To give only a few non-limiting examples, the further electric connecting device may be arranged in the region of the chassis, in the region of a frame, in the region of a baggage receiving device, in the region of a goods receiving device, in the region of a shopping cart receptacle or a shopping cart platform or at any other point of the pushable transport cart, wherein the further electric connecting device can also not be provided on the handling device intended for pushing the pushable transport cart. The further electric connecting device can, for example, be arranged lower than the handling device of the pushable transport cart, in particular in the floor area, in an area that the user can only reach by bending down, or at a height that is less than 100 cm or less than 70 cm or less than 50 cm or less than 30 cm above the floor. According to a preferred embodiment, the electric connecting device integrated in the mechanical connecting device and the further electric connecting device are distanced from each other by a distance that is larger than 20 cm or larger than 30 cm or larger than 50 cm or larger than 70 cm or larger than 90 cm. In one embodiment, the electric connecting device and the further electric connecting device form at least one closed circuit, wherein the electric circuit comprises a feed line from the stockage and/or charging station or the neighboring pushable transport cart to the pushable transport cart, which is provided by the electric connecting device, and a return line, which is provided by the further electric connecting device and leads back from the pushable transport cart to the stockage and/or charging station or to the neighboring pushable transport cart. In this case, the electric circuit is only closed when both electric connecting devices establish a connection. The closed electric circuit can then be used, for example, to transmit electric power (or data or signals). If, in contrast to this embodiment, a closed circuit is provided solely by the electric connecting device integrated into the mechanical connecting device, so that connections for the supply line and the return line are present on the same component, contact between the user and both connectors could lead to a short circuit via the user, which could be uncomfortable for the user or even cause damage to health. Such a short circuit is made more difficult or avoided for the embodiment explained here: If, for example, the further electric connecting device is located in the area of the chassis of the pushable transport cart, the user would have to contact both electric connecting devices simultaneously for such a short circuit and bridge the distance between these two electric connecting devices, which is unlikely or impossible depending on the position of the connecting devices.

For a further option, the mechanical connecting device comprises a securing chain. Here it is quite possible that an electric conductor of the electric connecting device is embodied as a separate unit from the securing chain, but as a spatially combined unit. For a particular proposal, loosely adjacent members of the securing chain form an electric conductor of the electric connecting device, whereby additional insulation can then surround the securing chain or the members of the securing chain can comprise insulation away from the contact points of the same. If the currents and/or voltages that are transmitted via the conductor formed by the members of the securing chain are so small that they do not lead to impairment of the user when the user comes into contact with the members of the securing chain, or if only one branch of an otherwise closed circuit is transmitted via the members and the electronic connecting device, the securing chain or the members of the securing chain may not be insulated at all.

A coin-operated lock of a type known in principle may be present in the pushable transport cart, wherein the insertion of a coin into the coin-operated lock is required to release the mechanical connecting device. However, it is also possible for any other mechanical securing, latching and locking device to be used. It is also possible, for example, that a lock operated by means of an electric actuator is used, which can be operated by a user by means of a portable, network-compatible electronic device (in particular a smartphone by means of an app from the person or company running the shopping center).

There are many options for the design of the connecting devices of the pushable transport cart, some of which are also known from the prior art. For one proposal, the mechanical connecting device comprises an electrically conductive plug-in tongue and a plug socket. A plug-in tongue of a pushable transport cart can then be plugged into the plug socket of an adjacent pushable transport cart. In this case, the plug socket can comprise an elastic or elastically supported electric contact element, which then forms an electric contact with the plug-in tongue. The contact element can be embodied as a spring contact or elastic contact clamp, for example, into which the plug-in tongue can be inserted. Alternatively or cumulatively, it is possible that the plug-in tongue comprises a latching or locking surface. The snap-in or interlocking surface of the plug-in tongue interacts with a snap-in or interlocking element of a plug socket of the adjacent pushable transport cart or the stockage and/or loading station for latching or locking.

The electric connecting device may comprise any number of connectors, connector bars or interfaces depending on the requirements of the electric signals, data, currents or voltages to be transmitted. For a particular proposal, the electric connecting device comprises redundant connectors, connector bars or interfaces. The redundant connectors, connector bars or interfaces can then each be used for different assembly orientations of the mechanical connecting device. To give merely one non-limiting example, a plug of a pushable transport cart can be inserted into a plug socket of an adjacent pushable transport cart in two orientations rotated by 180° about its longitudinal axis. In this case, the redundant connectors, connector bars or interfaces are arranged on opposite sides in the circumferential direction around the longitudinal axis and at the same distance from the longitudinal axis so that for each of the two different assembly orientations, one connector, connector bar or interface of the two redundant connectors, connector bars or interfaces is arranged in the same position so that it or they can then interact with a single connector, connector bar or interface of the other pushable transport cart. In this way, use is simplified for the user and incorrect assembly, in which the electric contacting does not meet the requirements, is reliably avoided. Preferably, the mechanical connecting device mechanically provides the two possible assembly orientations, which can be ensured, for example, by corresponding geometries of the cross-section of the plug-in tongue and the associated plug socket.

While the electric connecting device and the two electric components of the pushable transport cart and the adjacent pushable transport cart or the stockage and/or charging station, which are connected to each other, can be embodied as desired in terms of design and geometry, the electric connecting device for a pushable transport cart preferably comprises a plug and/or a plug socket. In this case, the plug or the plug socket may comprise an electric plug contact element. This electric plug contact element can then be elastic or elastically supported in the direction of insertion of a plug into the plug socket. For this embodiment, it is possible for the mechanical connecting device to be mounted via a certain assembly path in the direction of insertion of the plug into the plug socket, whereby the plug can be guided in the plug socket along this assembly path. In a final section of the assembly path, the elastically supported or elastic electric contact element can then come into contact with a contact surface of the plug or the plug socket. With further assembly along the last part of the assembly path, the electric plug contact element is then subjected by an increasing contact force, which results in an increasing elastic deformation of the electric contact element itself or the elastic support thereof. In this way, on the one hand, the desired contact force of the contact element can be ensured. On the other hand, this elastic contact displacement of the contact element results in a robustness of the electric plug contact element independent of any fluctuations in the assembly path and/or manufacturing tolerances.

It is possible that the plug and the plug socket form an insertion support, which can be used, for example, for a type of centering over the assembly path. Preferably, this insertion support ensures that the longitudinal axes of the plug and the plug socket are already aligned before the start of the contacting path or last partial path, so that when the contact element of the plug or the plug socket comes into contact with the plug socket or the plug, the contact element already comes into contact with the intended contact surface. This enables precise contacting, the user being assisted by the insertion support.

For one embodiment of a pushable transport cart, the mechanical connecting device comprises a magnet, which is in particular a permanent magnet. Preferably, the plug of a pushable transport cart and the plug socket of the adjacent pushable transport cart each comprise a permanent magnet, with the poles of these permanent magnets being oriented in such a way that the two permanent magnets attract each other when the mechanical connection is established. The permanent magnets of the mechanical connecting device can be used to secure the mechanical connection with a magnetic force. This magnetic force can also ensure that the electric connection created via the electric connecting device is secured against unintentional loosening. However, it is also possible that only one permanent magnet is arranged either in the plug [or in the plug socket], which then generates a magnetic force with a metallic body in the plug socket [or in the plug]. An electromagnet can also be used instead of the at least one permanent magnet. In addition to ensuring contact between the plug and the plug socket, the at least one magnet also provides a mechanical securing force. If an electromagnet is used, the release of the mechanical lock by the electromagnet can be made dependent on the authentication of a user.

It is quite possible that all electric contacts of the pushable transport cart are established via the electric connecting device. Preferably, the further electric connecting device is embodied as and arranged in such a way that, when the pushable transport cart is pushed into an adjacent pushable transport cart, it automatically brings about an electric connection in a motion-controlled manner as a result of the pushing into one another. Alternatively or cumulatively, the further electric connection device can form an electric contact with the stockage and/or charging station when the pushable transport cart is pushed into the stockage and/or charging station, e.g. with a charging bar of the stockage and/or charging station that enters between the right and left wheels of the pushable transport cart or with a charging bar on one side of the wheels of the pushable transport cart or on one side of a chassis, frame or shopping goods or baggage receiving device. The electric connecting device integrated into the mechanical connecting device is thus contacted by manually coupling the mechanical connecting device, while the other electric connecting device forms an electric connection by pushing the pushable transport carts into one another or by pushing the pushable transport cart into the stockage and/or charging station. Although physically separate electric connecting devices are used, the effort required by the user to operate the connecting devices is not significantly increased.

It is in principle possible for the two electric connection devices to be used for different purposes, in particular for transmitting different signals, for transmitting data on the one hand and electric power on the other hand, and the like. The electric connecting device can include any number of connections, which can be embodied as individual connections, integrated into a connector or plug strip or provided in an interface of any design. It is possible, for example, that the electric connecting device may comprise connectors for an electric power supply. In this case, the electric connecting device and/or the electric and electronic components of the pushable transport cart connected to the electric connecting device can be embodied as being operated with direct current or alternating current provided via the connectors.

Alternatively or cumulatively, it is possible that the electric connecting device comprises at least one connector for a charging station detection. This charging station detection can, for example, comprise a lead looped through a line of interconnected pushable transport carts, via which an electric signal can be received by a control unit of the pushable transport cart, which provides information as to whether the line of pushable transport carts is connected to a charging station and thus whether a charging voltage is applied to the line of pushable transport carts or not. Alternatively or cumulatively, the electric connecting device may comprise an (auxiliary) connector via which any additional signals can be transmitted or measurement signals from sensors of adjacent pushable transport carts can be transmitted. Alternatively or cumulatively, the electric connecting device may comprise at least one connector for signal transmission and/or data transmission.

It is quite possible that the storage device in the pushable transport cart is permanently connected to the electric connecting device, wherein it is possible that whenever a supply voltage is applied to the electric connecting device, the storage device is supplied with the supply voltage and, depending on the storage status, the storage device is charged. In one embodiment of the pushable transport cart, the pushable transport cart comprises a storage release device. The storage release device is interposed between the electric connecting device and the storage device and is designed in such a way that the storage release device connects the storage device to the electric connecting device in a release position thereof in order to enable the charging state of the storage device to be changed via the electric connecting device. On the other hand, the storage release device also has a disconnected position. In the disconnected position, the storage release device electrically disconnects the storage device from the electric connection device. In the simplest case, the storage release device is embodied as a type of electronic switch comprising the release position and the disconnected position. The release position can be used to change the charging status of the storage device, which may be accomplished in that the storage device is charged by a charging voltage applied to the electric connecting device. It is also possible that the storage device is discharged in the release position so that the storage device can deliver electric power to an adjacent pushable transport cart via the electric connection device.

If the storage release device is in the disconnected position, the voltage applied to the electric connecting device cannot be processed. It is also possible that the voltage present here is not used to change the charge state of the storage device, but is passed on from the pushable transport cart to a neighboring pushable transport cart.

If the electric connecting device has a plug and a plug socket, a charge flow control unit may be present. This charge flow control unit is then interposed between the plug and the plug socket. Furthermore, the charge flow control unit connects the plug or the plug socket to the storage device, which can be done via the storage release device if appropriate. The charge flow control unit can then comprise two different operating modes, namely a pass-through operating mode and a charging operating mode:

In the pass-through operating mode, the charge flow control unit connects the plug to the plug socket so that electric energy can be passed through the pushable transport cart for transmission to an adjacent pushable transport cart. In the pass-through operating mode, the charge flow control unit simultaneously disconnects the storage device from the plug or the plug socket so that the charging status of the storage device is not affected.

On the other hand, the charge flow control unit disconnects the plug from the plug socket in the charging mode, so that no electric energy is passed through or transferred. Instead, in the charging mode, the charge flow control unit ensures that the storage device is connected to the plug or the plug socket, allowing the storage device to be charged (or discharged) via the plug or the plug socket.

Under certain circumstances, it may be desirable for a line of pushable transport carts connected to a charging station to only pass electric energy from the charging station in one direction to the pushable transport cart located furthest away from the charging station, while not enabling current to flow in the opposite direction. In this case, a direction setting current flow element, in particular a diode, can be connected between the plug and the plug socket. If, on the other hand, the direction of the possible current flow is to be controllable, a bypass to the diode or to the component that determines the direction can also be provided, the release of which also allows a reversal of the current flow.

A pushable transport cart may have a current sensor or switch. The current sensor or switch can be used to control or regulate the flow of electric signals. To cite merely one non-limiting example, a current sensor or switch can be arranged upstream of the plug or plug socket on the output side with respect to the charging station. If the pushable transport cart in the line of pushable transport carts connected to the charging station is the one connected furthest from the charging station, no current flows via this output-side plug or plug socket, as no other pushable transport cart is connected here. The current sensor or switch can therefore detect that no current is being passed through and thus causes the output-side plug or plug socket to be blocked. This can be done, for example, by switching the aforementioned charge flow control unit of this outermost pushable transport cart to the charging operating mode or by causing a disconnected operating mode of the charge flow control unit in which the input-side plug or the input-side plug socket is neither connected to the storage device nor to the output-side plug socket or the output-side plug.

It is possible that the charging station provides electric power by providing a DC voltage or an AC voltage, which can then be used to charge the storage device. For one proposal, it is also possible for the charging station to provide AC voltage. In this case, the pushable transport carts then have an AC/DC voltage converter that converts the AC voltage provided by the charging station into a DC voltage, which can then be used to charge the storage device.

For a further proposal, the pushable transport cart comprises a charging device by means of which a portable electronic device of the customer, in particular a smartphone, can be charged. Charging takes place from the storage device of the pushable transport cart, wherein alternatively or cumulatively or temporarily charging can also take place with energy from the charging station. The charging device can be connected wired or wirelessly to the customer's portable, network-compatible electronic device, for which purpose an inductive charging cradle can be used, for example.

It is quite possible that a voltage level provided by the charging station corresponds to the voltage level of the “on-board power supply” of the pushable transport cart. However, for a particular embodiment, the pushable transport cart comprises a voltage converter that changes the voltage level. Such a voltage converter may, for example, be a so-called buck-boost converter or inverse converter. To give just one non-limiting example, the charging station can provide electric power with a low voltage level, for example with a voltage level of maximum 24 V, maximum 12 V or maximum 5 V, whereby deviations from these maxima of ±2 V or ±1 V are also possible. The voltage level is selected in such a way that the user is not affected if a short circuit occurs via the user with this voltage level. This voltage level is then used exclusively for communication between the charging station and the pushable transport cart. The voltage level is then raised by means of the voltage transformer to a voltage level that is, for example, more than 20%, more than 50% or more than 100% higher than the previously specified voltage level and could lead to impairment of the user in the event of a short circuit of this voltage level via the user. The higher voltage level can then be used to operate the electronic devices and to charge and operate the storage device.

For a further proposal, a wireless transmitting and/or receiving device (in particular a Bluetooth device, a LoRa device, a BLE device and/or a WiFi device) is provided in the pushable transport cart. By means of the wireless transmitting and/or receiving device, the pushable transport cart can communicate with the stockage and/or charging station, a server and a computing unit of the shopping store, a checkout device of the shopping store and/or a portable, network-compatible electronic device of the customer in order to exchange any data in one of the directions or bidirectionally. If, for example, articles placed in a shopping cart are recorded, the articles can be transmitted to the checkout system via the wireless transmitting and/or receiving device, which can then trigger an automated payment process. However, it is also possible for products placed in the shopping cart to be optically detected using the customer's smartphone, for example by detecting the barcode. The detected article can then be transmitted to the pushable transport cart for further processing via the wireless transmitting and/or receiving device.

The electric connecting device (and possibly also the mechanical connecting device in which the electric connecting device is integrated) may comprise a flexible connecting cord which is connected in one end region to the plug or the plug socket, while the other end region of the flexible connecting cord may be connected, for example, to the handling device of the pushable transport cart, in particular a pushrod of the shopping cart or the baggage cart. In this case, it is possible that the connecting cord comprises a core, a jacket and/or a wire rope in order to absorb mechanical forces acting on the connecting cord and keep them away from electric connections and connecting leads.

For a particular proposal, an optical detection device is also integrated into the mechanical connecting device in addition to or with the electric connecting device. If the optical detection device is a barcode scanner or QR scanner, the mechanical connecting device is further optimized for multifunctional use in that it not only serves to integrate the electric connecting device and the mechanical connection, but also comprises the scanner, which can then be used to scan the articles to detect articles placed in a shopping cart.

A pushable transport cart system may have a plurality of pushable transport carts, which can be embodied as explained above, as well as a stockage and/or charging station. The stockage and/or charging station is connected (or can be connected) to one of the transport carts or several pushable transport carts connected to one another in a line.

Possible designs of control logic for operating the pushable transport cart or pushable transport cart system are mentioned and explained below. Here, the control logic is executed on a control unit of the pushable transport cart (in particular a charge flow control unit and/or a storage release device) and/or on a central control unit (for example a control unit of the stockage and/or charging station).

For one proposal, control logic is present in the pushable transport cart system or the pushable transport cart, which detects when the or a pushable transport cart is mechanically and/or electrically connected (or not connected) to an adjacent pushable transport cart. If such a connection is detected, the pushable transport cart can be locked, for example (in particular by locking the wheels of the pushable transport cart, by locking the mechanical connecting device by means of an actuator or by activating an electromagnetic connecting device). The lock can then be released later, for example by inserting a coin into a coin-operated lock on the associated pushable transport cart. It is also possible for the locking of the cart to be released via an app on the user's smartphone that communicates with the pushable transport cart. If, after the user has taken a pushable transport cart, the pushable transport cart is parked again in accordance with the regulations, which is recognized by the detection described above, a refund of an amount can be made to the user similar to a physical coin system, in particular via a customer app of the operator of the shopping market. It is also possible that if the app detects that the cart has been properly parked, an incentive is offered to the customer for his or her next purchase, which can create additional customer loyalty. The user's motivation to properly park the pushable transport cart can also be increased by displaying information about the user and the shopping behavior, such as a name and/or the list of purchases made, on a screen of the pushable transport cart until the cart is properly parked. Assuming that the user wishes to prevent this information from reaching third parties, the user is therefore motivated to park the cart properly.

Alternatively or cumulatively, it is possible for the pushable transport cart or the pushable transport cart system to have control logic that detects the number of pushable transport carts connected in a line to each other and/or to a stockage and/or charging station. This detection can be carried out, for example, by each pushable transport cart comprising a specific identifier exchanged between the line of pushable transport carts and/or the stockage and/or charging station. The detection of the specific identifier can then be used to determine the number of pushable transport carts. However, it is also possible that an electric transfer resistance between the pushable transport carts, which is dependent on the number of pushable transport carts connected to each other in line, is detected and the number of pushable transport carts connected to each other is then determined on the basis of the transfer resistance. Based on the determined number of interconnected pushable transport carts in line, it is then possible, for example, to control the charge management, to send a message or an alarm to a user or operator of the supermarket that there is an empty or overfilled pushable transport cart at a stockage station, or to direct the flow of customers to another stockage station where there is no risk of an empty cart.

It is possible that the pushable transport cart comprises an identifier specific to this pushable transport cart. This specific identifier can be used for a variety of purposes. For example, the specific identifier can be used to localize the individual pushable transport carts by means of a position detection system (in particular GPS) of the transport cart. Furthermore, the number of pushable transport carts connected in a line can be determined by recognizing the specific identifiers. It is possible that (for example in a control unit and storage device of the pushable transport cart, the stockage and/or charging station, a server of the supermarket and/or a checkout system of the supermarket) specific information for the pushable transport carts is collected (for example an operating time of the same, load parameters of the same and information such as date and type of repair and maintenance with possibly monitoring of repair or maintenance intervals).

Alternatively or cumulatively, there may be control logic that controls an exchange of electric energy between pushable transport carts that are connected to each other but not to a stockage and/or charging station. For this proposal, a higher charging level of a pushable transport cart can be used to partially charge at least one other pushable transport cart with a lower charging level. In the simplest case, the loading levels of the pushable transport carts connected to each other in the line are equalized to the same averaged loading level. It is also possible that the control logic ensures that a storage device providing the electric power is only discharged to a minimum charging level, which is dimensioned such that the minimum charging level ensures the continued operation of the pushable transport cart (at least for a reduced operating time). However, it is also possible, for example, that the control logic preferably prioritizes pushable transport carts that are further away from the charging station in such a way that electric power is transferred to them from storage devices that are located closer to the charging station, as it is more likely that the pushable transport cart receiving power from a storage device in this way will be used by a user in the near future. It is even possible that, in the event that at another time at least part of the line of interconnected pushable transport carts is connected to the stockage and/or charging station, the control logic brings about and/or controls or regulates a superimposition of the electric power supply by the charging station with the balancing of energy between the individual storage devices.

Alternatively or cumulatively, there may be control logic that ensures charge flow management. The charge flow management has a pass-through operating mode and a charging operating mode:
In the pass-through operating mode, the plug is connected to the plug socket (in particular via the aforementioned charge flow control unit), while the storage device is disconnected from the plug or the plug socket.
In charging mode, on the other hand, the plug is disconnected from the plug socket while the storage device is connected to the plug or the plug socket.
If the charge flow management recognizes that there is a greater load requirement on one pushable transport cart than on another pushable transport cart, the charge flow management switches the charge flow control unit of the first-mentioned pushable transport cart to the charge operating mode, while the at least one second-mentioned pushable transport cart is switched to the pass-through operating mode.

The criterion for determining which pushable transport cart comprises a higher charging requirement can, for example, depend on the respective charging levels, in that a lower charging level correlates with a higher charging requirement. Alternatively or cumulatively, the location of the pushable transport cart in the line of pushable transport carts can be taken into account-the greater the distance from the charging station, the greater the need for charging.

Alternatively or cumulatively, control logic can be provided that ensures charge flow management, in which a specific charging quantity for a supermarket or a baggage transport area is taken into account. This specific charging quantity correlates with the expected energy requirement for an average use of the pushable transport cart in the area of the supermarket or the baggage transport area. It is possible that a certain safety margin is added. If the shopping market is a small market, the specific charging quantity is smaller than for a large shopping market or even a shopping market with different stores, as in the latter case a user travels longer with the pushable transport cart for a usual shopping operation. The same pushable transport cart can be sold for different supermarkets or baggage transport areas, whereby the different specific charging quantities can still be taken into account. The specific charging quantity is taken into account for the charge flow management in such a way that, in the case of a higher specific charging quantity, the switchover from charging in particular a pushable transport cart located further away from the charging station to a pushable transport cart located closer to the charging station takes place when the charging level corresponds to the specific charging quantity.

Alternatively or cumulatively, control logic can be provided for a load flow management, in which specific demand parameters are taken into account for a shopping market or a baggage transport area and/or for a time and/or a day of the week, which correlate with an increased demand for the use of pushable transport carts per time unit by the users. If the frequency of use of a supermarket or a baggage transport area and the associated stockage station, at a peak time or at a day of the week with an increased number of users leads to pushable transport carts being removed from the stockage station at a higher frequency, this results in an increased specific demand parameter. For a larger specific demand parameter, care must then be taken to ensure that more pushable transport carts with a minimum charging level are provided at the stockage station during these “peak times”. This can lead to several pushable transport carts being charged simultaneously by means of the charge flow management, which are arranged on the side of the line of pushable transport carts facing the user, or, starting from the outermost pushable transport cart, the pushable transport carts are successively charged to a reduced voltage level as a result of the increased specific demand parameter. If, on the other hand, the specific demand parameter indicates that a pushable transport cart is only very rarely removed from the stockage station, the pushable transport cart furthest from the charging station can be charged to a higher voltage level.

For the specific demand parameter, a priori defined empirical values or empirical values determined over time during operation of the pushable transport cart system can be used. It is also possible for the specific demand parameter to be determined using self-learning or artificial intelligence and/or for the specific demand parameter to be taken into account in the charge flow management using self-learning or artificial intelligence.

Alternatively or cumulatively, it is possible that control logic is present in the pushable transport cart system, which ensures charge flow management in such a way that, in the case of a line of pushable transport carts connected to the stockage and/or charging station, the pushable transport cart furthest away from the stockage and/or charging station is charged first, until a threshold value of the charge status is reached. Then, successively the neighboring pushable transport carts in the direction of the stockage and/or charging station are charged. If a user connects a pushable transport cart to the end of the line facing away from the charging station during charging (in particular a pushable transport cart that is not furthest away from the charging station), a switchover can take place in such a way that this pushable transport cart, which is now furthest away from the charging station, is charged first.

The previously explained mechanisms can be used to determine the threshold value of the status of charge without this necessarily being the case.

Alternatively or cumulatively, the pushable transport cart system may have a control logic that ensures charge flow management in such a way that a storage device of a pushable transport cart is charged from a storage device of at least one other pushable transport cart. It is also possible for the charge flow management in selected operating states (in particular with an increased demand for charging a pushable transport cart, in particular on the basis of a detected large specific demand parameter) to charge a storage device of a pushable transport cart simultaneously from a storage device of at least one other pushable transport cart and from the charging station. This operation can also be described as a type of boost charging operation.

Previously, it was described how the charging management between the pushable transport carts can be dependent on the distance of the pushable transport carts from a charging and/or stockage station. The same can also apply to a line of pushable transport carts that are not connected to a charging station. In this case, the pushable transport cart adjacent to the charging station in the previous description corresponds to the first pushable transport cart in the line, into which the other pushable transport carts in the line are successively inserted from behind, while the pushable transport cart furthest from the charging station in the previous description corresponds to the last pushable transport cart in the line, which is therefore the first pushable transport cart to be removed from the line by the users.

For a further proposal, in the pushable transport cart system, the pushable transport carts and/or the stockage and/or charging station have/has control logic which detects when a separation of a pushable transport cart from another pushable transport cart and/or from a stockage and/or charging station occurs. This can be done, for example, using a switch between the pushable transport carts, using a distance sensor, using the dip in a signal transmitted between the pushable transport carts with the separation, using a change in the resistance of an electric line or a contact between the pushable transport carts or using the geodetic locations of the pushable transport carts. Alternatively or cumulatively, a separation of contact elements of the pushable transport carts, a separation of the mechanical connecting devices and/or the electric connecting devices can be detected in a corresponding or different way.

There are many ways of using a detected separation. For one proposal, in the pushable transport cart system, the pushable transport carts have control logic which activates a display of a pushable transport cart when a separation is detected, thereby preparing the pushable transport cart for use by the user. Alternatively or cumulatively, a wireless transmitting and/or receiving device can be activated. It is also possible that a tracking function is activated, by means of which a location tracking of the removed pushable transport cart is activated. On the one hand, this can be used to track the flow of customers in a supermarket or for the flow of baggage carts. However, it is also possible to use this for theft monitoring, whereby, for example, a theft warning is generated when the tracked location of the pushable transport cart leaves a defined territory. Alternatively or cumulatively, it is possible that a product scanner is activated when a separation is detected. By means of the product scanner the user can scan shopping products on a pushable transport cart embodied as a shopping cart before they are placed in the shopping cart. Alternatively or cumulatively, it is possible that when separation is detected, shopping processing software is activated which, for example, records the shopping items selected by the customer, provides the customer with information for their purchase, enables the shopping cart to communicate with the customer's cell phone and/or enables a (semi-automatic or fully automatic) payment process.

For another proposal, in the pushable transport cart system, the pushable transport carts have control logic that performs a self-test of the pushable transport cart when a separation is detected. Alternatively or cumulatively, an electric signal or a sensor signal of the pushable transport cart can be checked during the self-test to determine whether the pushable transport cart is functional or meets the specifications.

If the self-test leads to the result that there is an improper condition, for example the charge level of the storage device is not sufficient or there is an improper electric signal or sensor signal, the control logic of the pushable transport cart provides information to the user, which can e.g. be provided by an information on a display of the pushable transport cart or an acoustic signal. It is also possible for such information to be given to the user via the user's smartphone. In particular, an information is generated on a display of the pushable transport cart or the smartphone, which informs the user that the self-test was negative, shows the user the result of the self-test or prompts the user to use another pushable transport cart and/or to reconnect the pushable transport cart to a stockage and/or charging station or to a disposal area. Information can also be automatically generated and transmitted to an operator that the pushable transport cart is out of order.

It is also possible that the pushable transport carts of the pushable transport cart system have control logic which detects the establishment of a connection between two pushable transport carts, between contact elements, mechanical connecting devices and/or electric connecting devices.

If the establishment of such a connection is detected, a display of a pushable transport cart can be deactivated and/or a wireless transmission and/or reception device can be deactivated. Alternatively or cumulatively, a tracking function for tracking the location of the pushable transport cart can be deactivated, a product scanner can be deactivated and/or the previously explained purchase processing software can be deactivated.

For a particular proposal, the pushable transport carts have control logic that detects, based on a signal from a sensor, whether a shopping product or an item belonging to the user is still on the pushable transport cart when the connection is established. If this is the case, the user is informed that there is still a product or an item belonging to the user on the pushable transport cart. In this way, it is possible to prevent the user from accidentally forgetting a purchased product, for example, when the pushable transport cart is set down in the pushable transport cart after the shopping process has been completed. Detection can be based on a signal from a load cell, which records the weight of the product forgotten on the pushable transport cart. Alternatively or cumulatively, detection can be based on a sensor in the form of a camera, which captures the forgotten item as an image using automatic image recognition software to analyze the image captured by the camera.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE FIGURES

In the following, the invention is further explained and described with reference to preferred embodiments shown in the figures.

FIG. 1 shows a top view of connecting devices of two pushable transport carts.

FIG. 2 shows a section II-II through the connecting devices of two pushable transport carts as shown in FIG. 1.

FIG. 3 shows a section III-III through the connecting devices of two pushable transport carts as shown in FIGS. 1 and 2.

FIG. 4 shows a plug of the connecting devices of two pushable transport carts according to FIGS. 1 to 3 in a spatial view.

FIG. 5 shows an alternative design of connecting devices of two pushable transport carts in a top view.

FIG. 6 shows a section VI-VI through the connecting devices of two pushable transport carts as shown in FIG. 5.

FIG. 7 shows spring-loaded contact elements of a plug of the connecting devices of two pushable transport carts according to FIGS. 5 and 6.

FIG. 8 shows a plug of the connecting devices of two pushable transport carts according to FIGS. 5 to 7 in a spatial view.

FIG. 9 shows a plug socket of the connecting devices of two pushable transport carts according to FIGS. 5 to 8 in a spatial view.

FIG. 10 shows a section through another embodiment of connecting devices of two pushable transport carts.

FIG. 11 shows a detail of a plug socket of the connecting devices of two pushable transport carts according to FIG. 10.

FIG. 12 shows a plug of the connecting devices of two pushable transport carts according to FIGS. 10 and 11.

FIGS. 13 to 18 show electric schematic circuit diagrams of embodiments of a pushable transport cart system with a charging station and three pushable transport carts connected in a line.

### DETAILED DESCRIPTION

In the figures, components and features which correspond or are similar are sometimes identified with the same reference signs, whereby these components or features can then be distinguished from one another by the addition “-1”, “-2”, . . . . Reference can then also be made to these components and features without the addition, which can then mean one such component or feature, any number of such components or features or all components or features identified in this way.

In the figures, different pushable transport carts and their components are distinguished from each other by the letters a, b, c. These pushable transport carts and their components can then also be referred to without the letter, which can then mean a pushable transport cart or a component, any number of such pushable transport carts and components or all pushable transport carts and components marked in this way.

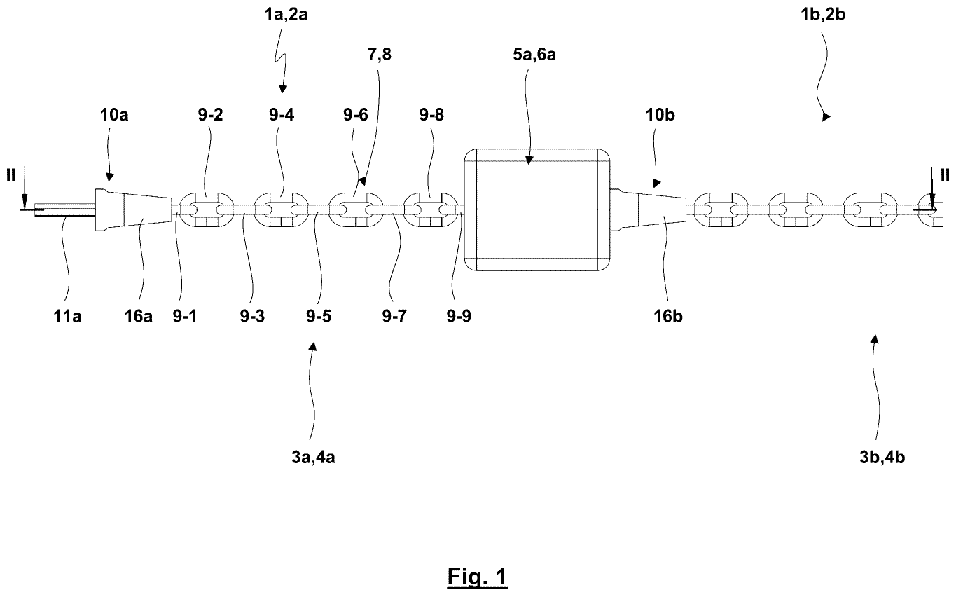

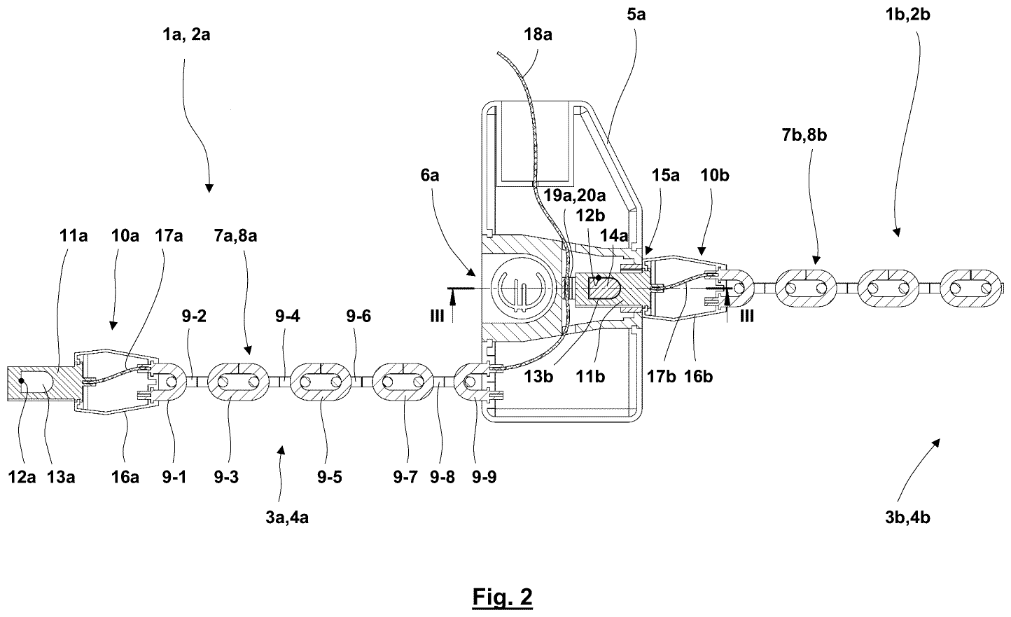

FIG. 1 shows a mechanical connecting device 1 and an electric connecting device 2 of two pushable transport carts 3a, 3b, which are in particular shopping carts 4a, 4b. The connecting devices 1, 2 have a common housing 5. A coin-operated lock 6 of the mechanical connecting device 1 is arranged in the housing 5. The housing 5 is connected to a plug 10 via a flexible connecting cord 7 (here a securing chain 8 with (chain) members 9a, 9b, . . . ).

The plug 10 has a plug-in tongue 11. The plug-in tongue 11 comprises a snap-in or interlocking surface 12. For the embodiment shown, the snap-in or interlocking surface 12 is embodied as a through-recess 13 of the plug-in tongue 11. In the snap-in or interlocking position of the coin-operated lock 6, a snap-in or interlocking element 14 engages or locks with the snap-in or interlocking surface 12. For the illustrated embodiment example, this is achieved by the snap-in or interlocking element 14 entering the through-recess 13 in a form locking manner. The snap-in or interlocking element 14 is arranged in a plug socket 15 of the housing 5 and coin-operated lock 6, into which the plug 10 can be inserted. If there is a coin in the coin-operated lock 6, the snap-in or interlocking element 14 releases the plug-in tongue 11, allowing the plug 10 to be removed from the plug socket 15. If, on the other hand, there is no coin in the coin-operated lock 6, the plug 10 is secured in the plug socket 15 by the interaction between the snap-in or interlocking element 14 and the snap-in or interlocking surface 12. Preferably, the snap-in or interlocking element moves between the snapped-in or interlocked position and the non-snapped-in or non-interlocked position transversely to the insertion direction of the plug 10 into the plug socket 15. If the plug 10 is arranged in the plug socket 15 and the coin-operated lock 6 is in the snapped-in or interlocked position, the mechanical connecting device forms a safeguard for the two pushable transport carts 3a, 3b pushed into one another against being pulled apart and thus against removal and use of a pushable transport cart 3b.

The electric connecting device 2 is integrated into the mechanical connecting device 1. For this purpose, the plug-in tongue 11 is embodied as electrically conductive. The end region of the plug-in tongue 11, which is arranged in a plug housing 16, is contacted by one end region of a connecting cable 17. The other end region of the connecting cable 17 contacts the member 9-1 of the securing chain 8, which is firmly connected to the plug housing 16. As a result of gravity, the interlocking members 9-1, 9-2, . . . are in contact with each other. As a result of this contact and the electrically conductive design of the members 9, the securing chain 8 forms an electric conductor. The member 9-9 furthest away from the plug 10 is permanently connected to the housing 5. This member 9-9 is electrically contacted by a connecting cable 18 extending through the housing 5.

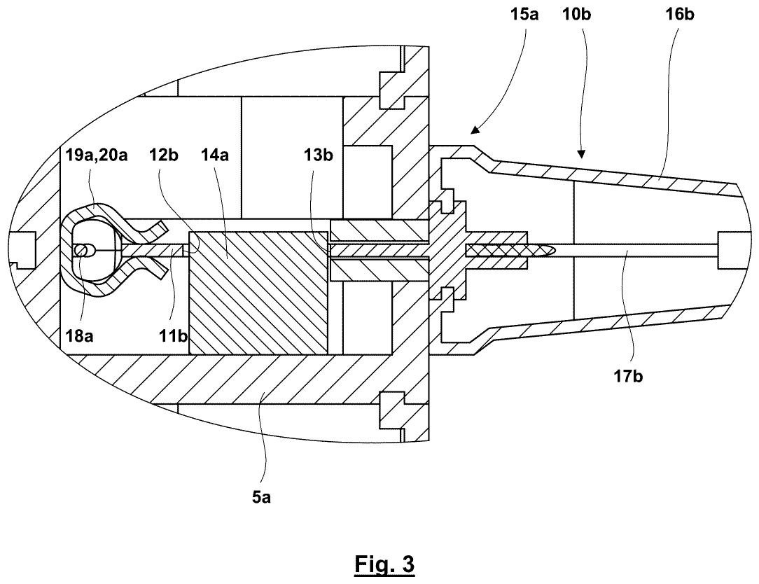

An electric plug contact element is located in the plug socket 15, which is embodied as an elastic contact clamp 20 for the embodiment shown. The contact clamp 20 has a roughly U-shaped cross-section. The base leg of the U is attached to the housing 5, while the plug-in tongue 11 can be inserted between the side legs of the U with elastic expansion of the side legs. The contact force between the contact clamp 20 and the plug-in tongue 11 is brought about by the elastic restoring force of the contact clamp 20. The connecting cable 18 is connected to the base leg of the contact clamp 20 (see FIG. 3.).

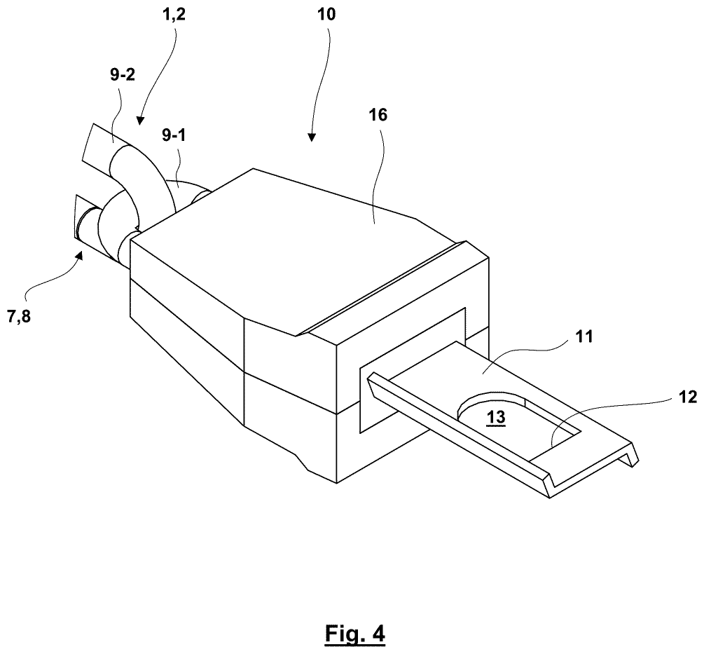

FIG. 4 shows a three-dimensional view of the plug 10 with the plug-in tongue 11. It can be seen here that the plug-in tongue 11 comprises angled edges oriented in opposite directions. The plug socket 15 has a correspondingly shaped receiving contour, so that form-fit insertion of the plug 10 with the plug-in tongue 11 into the receiving contour of the plug socket 15 is possible in two orientations rotated by 180° around the longitudinal axis of the plug 10.

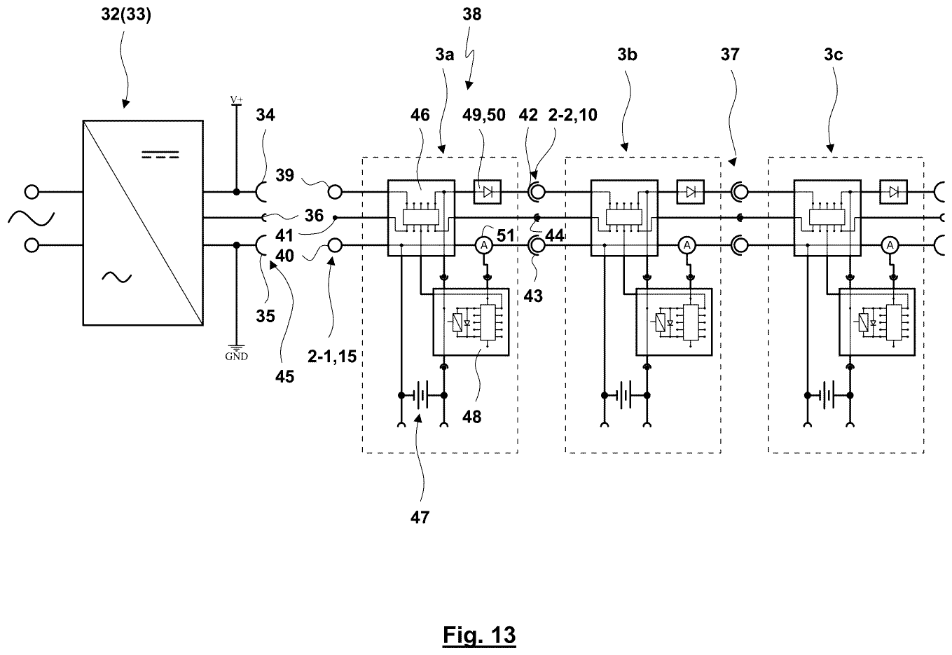

The connecting cable 18 is connected to other electronic components of the pushable transport cart 3a in a manner not shown, as will be explained in more detail below with reference to FIGS. 13 to 18.

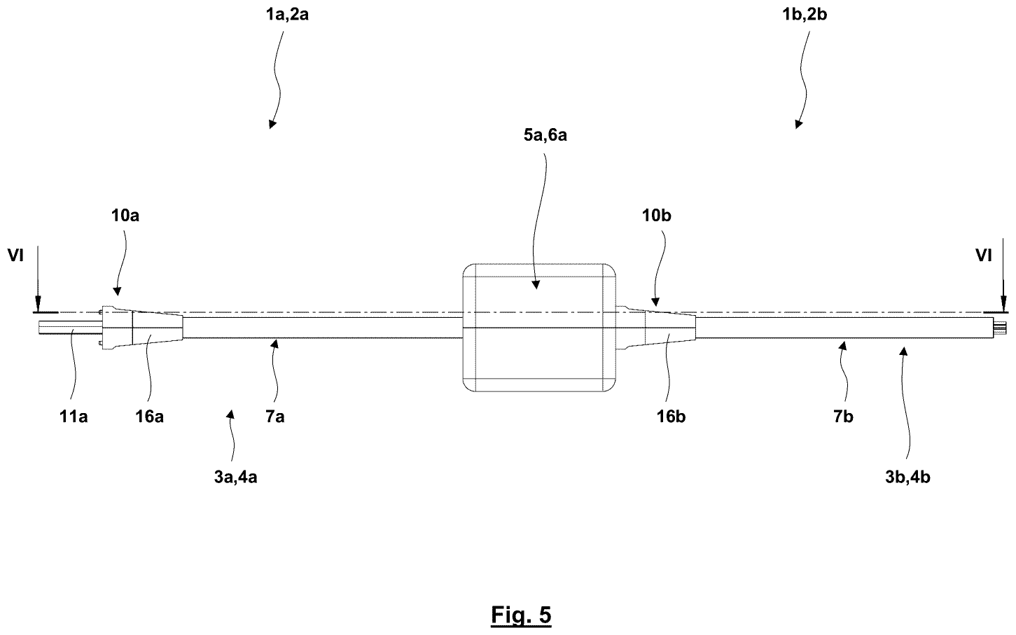

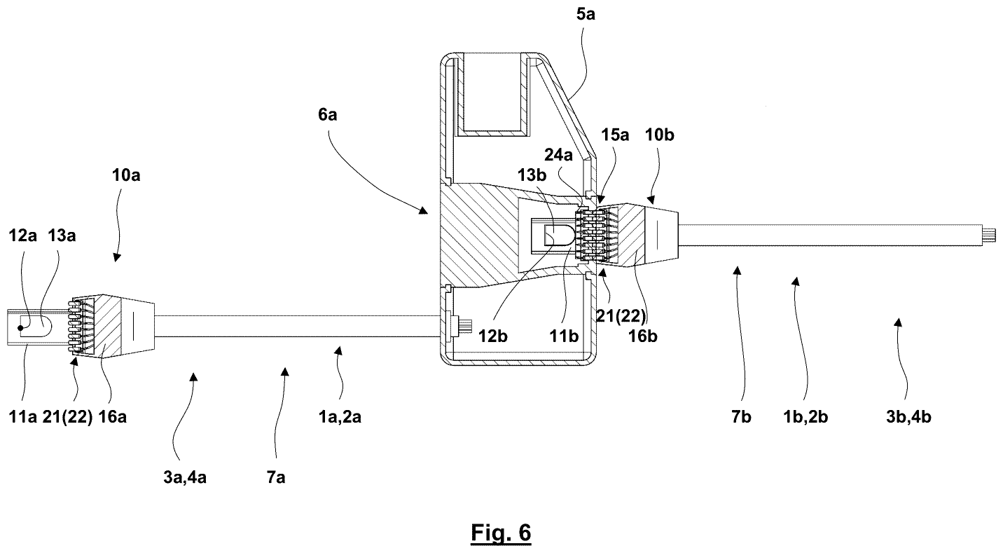

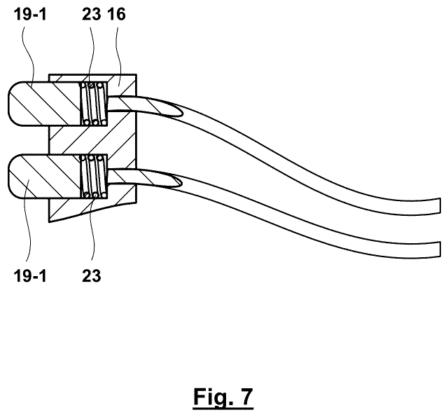

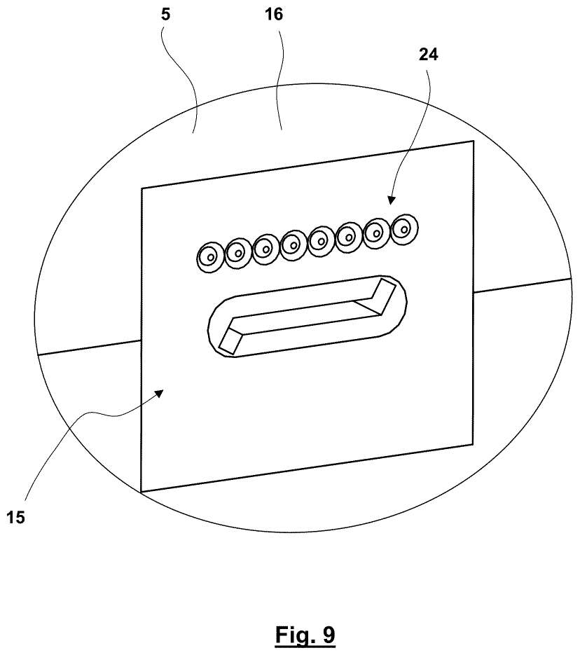

FIGS. 5 to 9 show another embodiment in which the plug 10 comprises two connector bars 21, 22 arranged on opposite sides of the plug-in tongue 11 on the end face of the plug housing 16, each comprising a plurality of contact elements 19. As can be seen in particular in the partial section in FIG. 7, the contact elements 19 are themselves embodied as rigid here, but are supported in the plug housing 16 via springs 23. In each case, a pair of contact elements 19 arranged in the connector bars 21, 22 in the corresponding position are connected to a common electric conductor in order to ensure that the plug 10 can also be inserted into the plug socket 15 in two orientations rotated by 180° about the longitudinal axis with the desired electric contact for this embodiment. The plug socket 15 comprises only one connector bar 24, which then interacts with the connector bar 21 in a first orientation of the plug 10, while the same connector bar 24 of the plug socket 15 interacts with the other connector bar 22 in the second orientation.

For the embodiment shown, the connecting cord 7 is not embodied as a securing chain 8, but as a multi-core cable of the electric connecting device 2, whereby the multi-core cable can be provided with reinforcement and/or insulation or sheathed to form the mechanical connecting device 1. In this case, the plug-in tongue 11 is not part of the electric connecting device.

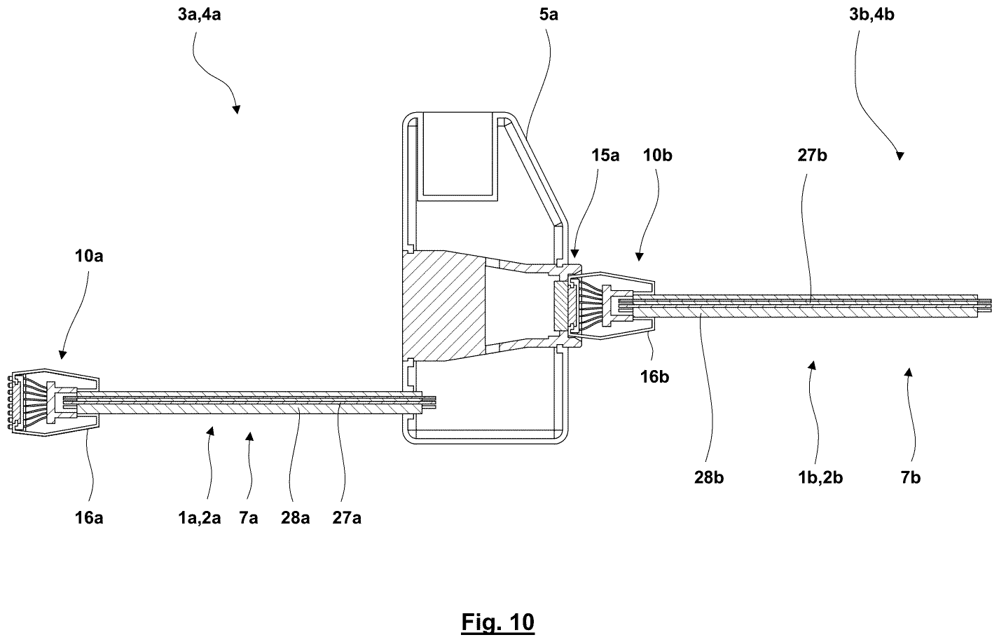

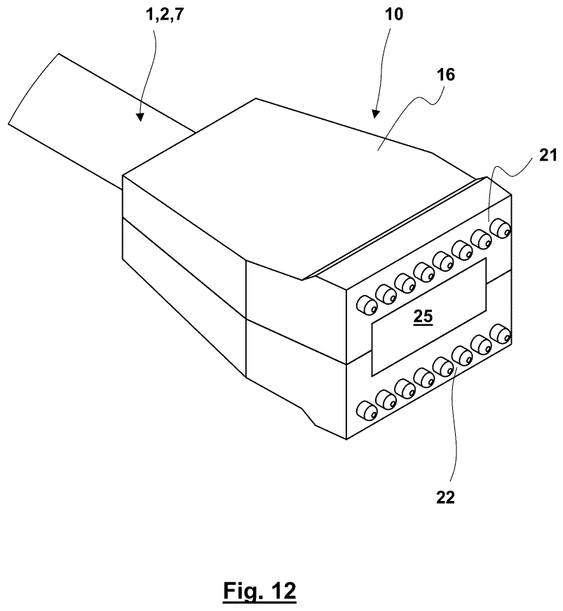

For the embodiment according to FIGS. 10 to 12, the plug socket 15 and the plug 10 each have a permanent magnet 25, 26 which, when the plug 10 is inserted into the plug socket 15, lie against each other and secure the mechanical and electric connection created. However, it is also possible that only one permanent magnet 26 [or 25] is provided on the plug socket 15 [or on the plug 10], which then generates a magnetically securing connection force with a metallic counterpart of the plug 10 [or the plug socket].

Furthermore, FIGS. 10 to 12 show a possible structure of the connecting cord 7. In this case, a multi-core cable 27 or several cables extend through a jacket 28, which is preferably a Kevlar jacket.

In the embodiment shown in FIGS. 10 to 12, the plug 10 does not have a plug-in tongue 11. Instead, the permanent magnet 25 and the connector bars 21, 22 are arranged in the area of the (here flat) end face of the plug 10.

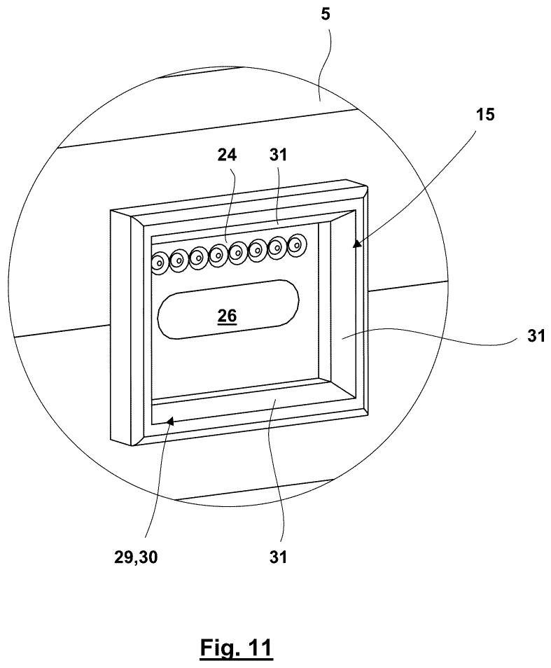

FIG. 11 shows that the plug socket 15 comprises an insertion support 29. For the embodiment shown, the insertion support 29 has a frame 30 surrounding the plug 11 in the inserted state, comprising insertion chamfers 31 whose intermediate space tapers in the direction of insertion of the plug 10 to create a centering effect.

FIG. 13 shows a charging station 32, which can also be a stockage station 33 for pushable transport carts 3. The charging station 32 as shown in FIG. 13 provides electric power by means of a DC voltage. The charging station 32 comprises connectors 34, 35, 36. The connectors 34, 35 are used for the electric power supply and thus for charging the pushable transport cart 3 with electric energy. The further connector 36 forms an auxiliary contact that can be used, for example, to detect the (direct or indirect) connection of the pushable transport cart 3 to the charging station 32.

FIG. 13 shows a line 37 in which three pushable transport carts 3a, 3b, 3c are connected to each other in an electric line circuit. In the operating position of the pushable transport cart system 38 formed in this way as shown in FIG. 13, the line 37 of pushable transport carts 3 is not connected to the charging station 32.

The pushable transport carts 3 are embodied as identical, at least with regard to the electric components.

The pushable transport cart 3 has connectors 39, 40, 41 on the input side and connectors 42, 43, 44 on the output side. The connectors 39, 40, 41 on the input side form a first electric connecting device 2-1, while the connectors 42, 43, 44 on the output side form an electric connecting device 2-2 on the output side. An input side connecting device 2-1 of the pushable transport cart 3 can be connected to the connectors 34, 35, 36 of the charging station 32 or an output-side connecting device 2-2 of a neighboring pushable transport cart 3. However, it is also possible for a side designated here as the “input side” to form an output side and vice versa, whereby a change from the input side to the output side and vice versa is also possible depending on the mode of operation.

In FIG. 13, the electric components of the pushable transport cart 3 are marked with reference numbers only for the pushable transport cart 3a, whereby the same applies to the other pushable transport carts 3. The connectors 42, 43, 44 and the electric connecting device 2-2 formed with them thus correspond to the connectors 34, 35, 36 and a correspondingly formed electric connecting device 45 of the charging station 32.

One of the connecting devices 2-1, 2-2 is embodied as a plug 10, while the other connecting device 2-2, 2-1 is embodied as a plug socket 15. In FIG. 13, for example, the connecting device 2-1 is embodied as a plug 10, while the other connecting device 2-2 is embodied as a plug socket 15 (while a reverse design is also possible).

The plug 10 and the plug socket 15 are connected to one another via a charge flow control unit 46, which is preferably an electronic control unit with control logic. The charge flow control unit 46 comprises a pass-through operating mode in which the plug 10 is connected to the plug socket 15. Furthermore, the charge flow control unit 46 may comprise a disconnection operating mode in which the plug 10 is disconnected from the plug socket 15. In particular, the disconnection operating mode can be a charging operating mode or there is an additional charging operating mode in which the plug 10 is disconnected from the plug socket 15, but the plug 10 is connected to a storage device 47 of the pushable transport cart 3 via the charge flow control unit 46. In this case, the connection between the charge flow control unit 46 and the storage device 47 can be made via a storage release device 48. The storage release device 48 can then have a release position in which the storage device 47 is connected to the charge flow control unit 46, which makes it possible to charge the storage device 47 via the charge flow control unit 46 or to use the charge of the storage device 47 to charge a storage device 47 of another pushable transport cart 3 via the charge flow control unit 46. Furthermore, the storage release device 48 has a disconnected position in which (as shown, at least one branch) between the storage device 47 and the charge flow control unit 46 is shut off.

Between corresponding connectors 39, 42, which are connected to one another in the pass-through operating mode of the charge flow control unit 46, a direction setting current flow element 49 can optionally be arranged, which is embodied as a diode 50 for the illustrated embodiment. The current flow element 49 enables a charge flow from the charging station 42 via a pushable transport cart 3a to an adjacent pushable transport cart 3b arranged further away from the charging station 32, while an electric flow in the opposite direction is blocked.

Furthermore, a current sensor 51 is arranged between corresponding connectors 40, 43, which are connected to each other in the pass-through operating mode of the charge flow control unit 46.

Without this being absolutely necessary, for the embodiment according to FIG. 13, the current flow element 49 on the one hand and the current sensor 51 on the other hand are arranged in different line branches via which charging from the charging station 32 takes place.

The output signal of the current sensor 51 is fed to the storage release device 48. The current sensor 51 detects when a neighboring pushable transport cart 3b is connected to the pushable transport cart 3a of this current sensor 51, the charge flow control unit 46 is in the pass-through operating mode and thus current is transmitted via the electric connecting devices 2-2, 2-1 from the pushable transport cart 3a to the pushable transport cart 3b (or another pushable transport cart 3 in line 37). If such a current is transmitted, the supply of the output signal of the current sensor 51 to the storage release device 48 can be used to transfer the storage release device to the locked position. If, on the other hand, it is detected that no neighboring pushable transport cart 3b is connected to the connector 43 of the pushable transport cart 3 or that the charge flow control unit 46 of the neighboring pushable transport cart is in the charging mode, but in view of sufficient filling, the storage release device of the neighboring pushable transport cart 3b is in the disconnected position and thus no current is flowing via the connector 43, the signal from the current sensor 51 can be used to transfer the storage release device 48 to the release position.

The (auxiliary) connectors 41, 44 can be used to detect whether the pushable transport cart 3 is connected to a charging station 32. This information can then be processed in the charge flow control unit 46 and/or the storage release device 48 in order to bring about the different operating modes and positions.

Preferably, the charge flow control unit 46 has a control output via which the charge flow control unit 46 is in controlling connection (unidirectional or bidirectional) with the storage release device 48.

For the embodiment in FIG. 13, no charging of the line 37 can take place from the charging station 32 in view of the non-existent connection to the charging station 32. It is optionally possible for a pushable transport cart 3b, 3c to be charged from a storage device 47 of a pushable transport cart 3a arranged closer to the charging station 32.

If the line 37 is connected to the charging station 32, the pushable transport cart 3 of line 37 can be charged, whereby the operating modes and positions of the charge flow control unit 46 and the storage release devices 48 can be used to specify a charging sequence for the pushable transport cart 3a, 3b, 3c or to charge several or all storage devices 47 simultaneously. Preferably, the pushable transport cart 3c, which is furthest away from the charging station 32, is charged first with higher prioritization, followed by successive charging of the pushable transport carts 3b, 3a in the order of decreasing distance from the charging station 32.

In FIG. 13, redundant detection of whether there is a connection to the charging station 32 is possible by evaluating, on the one hand, the signal at the connectors 41, 44 with the auxiliary line created above them to detect the charging station and, on the other hand, by evaluating the signal from the current sensor 51.

According to another embodiment, the connectors 39 and 40 of the pushable transport cart 3a can be provided at a distance from each other. For example, the connector 39 can represent a first electric connecting device [or second electric connecting device] and the connector 40 can represent a second electric connecting device [or first electric connecting device]. The connector 39 may e.g. be located at the handle of the pushable transport cart 3a, whereas the connector 40 can e. g. be located on the chassis frame.

Furthermore, for this embodiment the first electric connecting device (connector 39) and the second electric connecting device (connector 40) can form an electric circuit, such that the electric circuit comprises a feed line from the stockage and/or charging station 32 or another pushable transport cart 3b, 3c to the pushable transport cart 3a, which is provided by the first electric connecting device, and a return line, which is provided by the second electric connecting device and leads back from the pushable transport cart 3a to the stockage and/or charging station 32 or to the other pushable transport cart 3b, 3c, wherein the electric circuit is only closed when both the first electric connecting device and the second electric connecting device establish a connection to the stockage and/or charging station 32 or to the other pushable transport cart 3b, 3c.

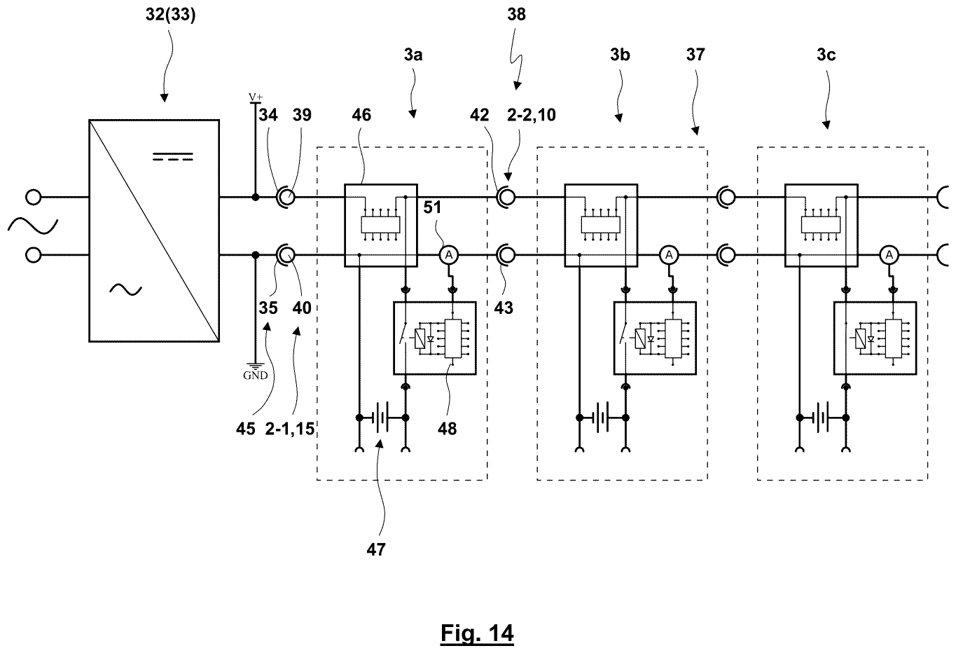

As FIG. 14 shows, an embodiment is also possible in which such an auxiliary line and thus the connectors 41, 44 are not present.

For the embodiment according to FIG. 14, the pushable transport carts 3 do not have a direction setting current flow element 49. This leads to the fact that a charging flow is not exclusively possible in one direction, but is possible in both directions. This means that, depending on the operating modes and positions of the charge flow control units 46 and the storage release devices 48, it is possible for electric energy to be transferred from a storage device 47 of a more distant pushable transport cart 3c to a pushable transport cart 3a, 3b arranged at a smaller distance from the charging station 32. Such a charge equalization in the line 37 can preferably be used to at least partially equalize the storage level of the storage devices 47 of the line 37 if there is no connection with charging station 32.

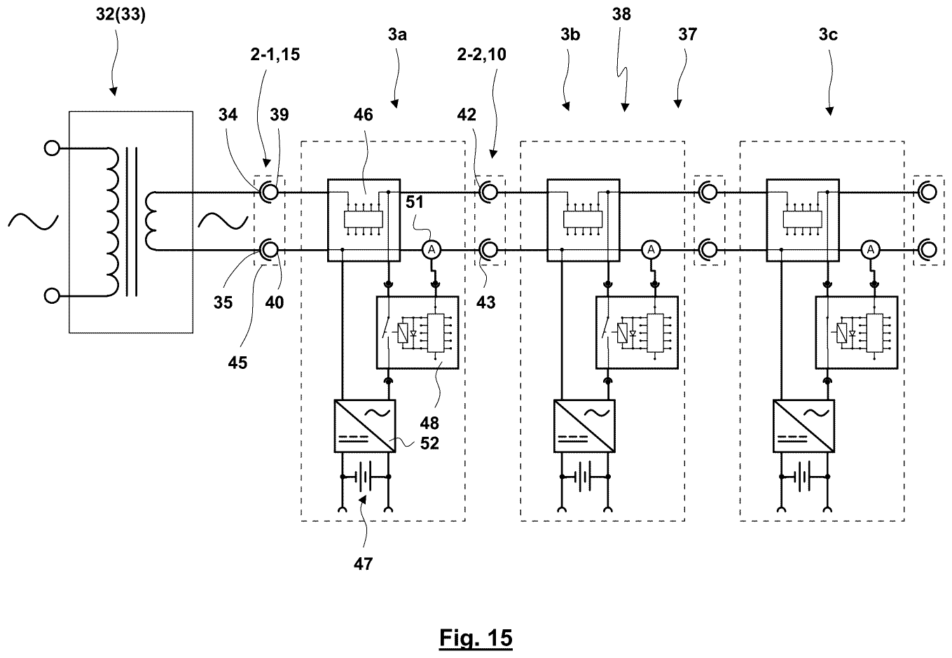

FIG. 15 shows an embodiment in which the charging station 32 provides an AC voltage rather than a DC voltage. In this case, an AC/DC voltage converter 52 is arranged upstream of the storage device 47, which in the charging mode provides the DC voltage required to charge the storage device 47.

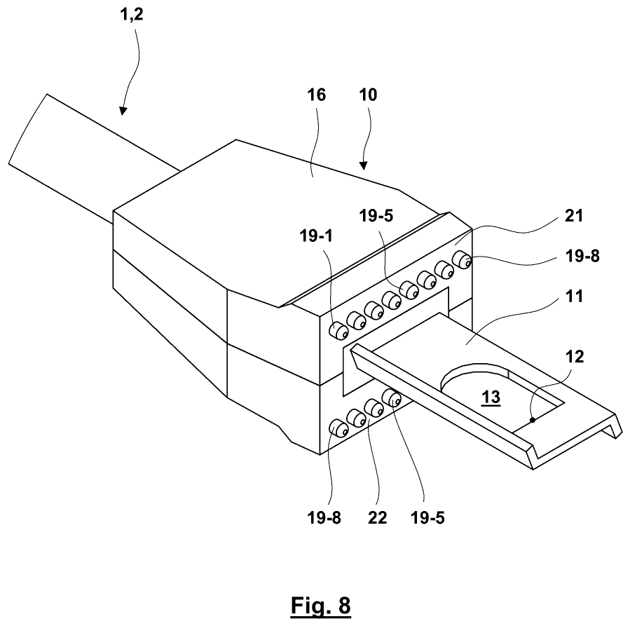

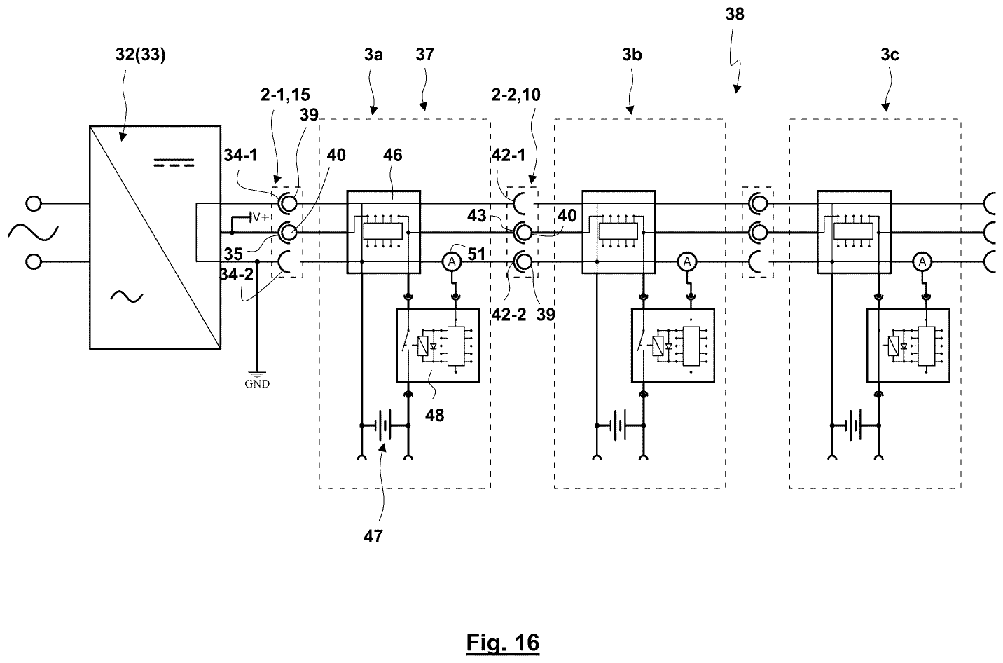

FIG. 16 shows an embodiment in which the electric connecting device of the charging station 32 and the electric connecting devices 2-2 of the pushable transport cart 3 comprise connectors that are connected to each other and have the same voltage level and are therefore redundant. These connectors can then be integrated into different connector bars 21, 23 of a plug 10 (see FIG. 8) in order to enable the plug 10 to be inserted into the plug socket 15 in two different rotational positions around the longitudinal axis and protected against polarity reversal.

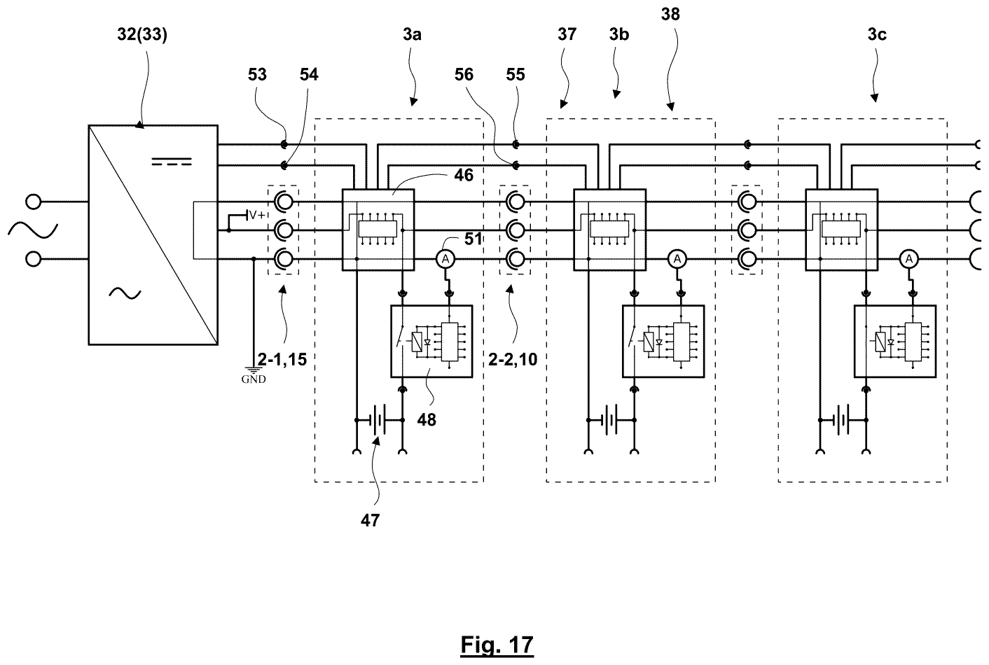

For the embodiment shown in FIG. 17, the connecting devices 2-1, 2-2 have further connectors 53, 54 on the input side and connectors 55, 56 on the output side. These connectors 53, 54, 55, 56 form auxiliary contacts for the transmission of further signals. For example, the connectors 53, 54, 55, 56 can be connectors of data lines by means of which data can be carried between the pushable transport cart 3 and/or the charging station 32. This data can, for example, relate to a recorded charge status of a storage device 47. It is also possible that a specific identification of a pushable transport cart 3 is transmitted, which, for example, enables the number of pushable transport carts 3 in the line 37 that are connected to the charging station 32 to be determined.

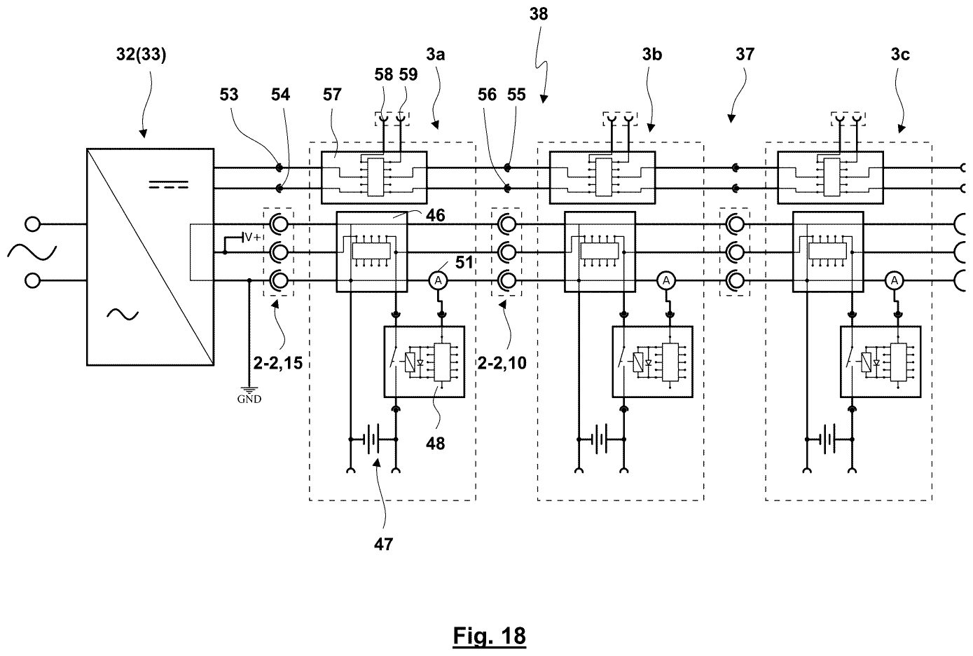

In FIG. 18 it can be seen that (in particular for the case of data transmission between the pushable transport carts 3 and/or the charging station 32 via connectors 53, 54, 55, 56) the pushable transport carts 3 each have a data processing unit 57, which is preferably an electronic control unit with control logic. The data processing 1 processing unit 57 can process the transmitted data and coordinate the sending and/or receiving of the data, for example by using suitable data protocols. Furthermore, FIG. 18 shows that the pushable transport cart 3 can have further connectors 58, 59, which can be auxiliary contacts or connections. For example, sensors can be connected to the connectors 58, 59, in particular a temperature sensor or an acoustic sensor, which detects the rolling noise of the rollers of the pushable transport cart 3 to analyze in which area with a specific surface design a pushable transport cart 3 is currently moving. The connectors 58, 59 are preferably connected to the data processing unit 57.

It is possible that the direction setting current flow element 49 can be bypassed by means of a bypass, whereby a switching device switched by a control unit can then be arranged in this bypass, which can activate or deactivate the bypass as required.

The charging station 32 can comprise any charging level, any charging power and any charging voltage. For example, the charging station 32 can be connected to a 230 V network and provide a DC voltage of 12 V. It is possible that the pushable transport cart 3 comprises a voltage converter that can increase or decrease the voltage level of the charging station 32. For the aforementioned charging station 32 with a power supply unit providing 12 V, the voltage can be increased by the voltage converter to a voltage level of 24 V, for example.

It is also possible that the charging station 32 has an electric storage device, buffer batteries and/or photovoltaic modules.

Instead of securing the pushable transport carts 3 to each other using a coin-operated lock 6, they can also be secured digitally. When using a customer-specific app, an unlocking process can be carried out by coupling with a wireless transmitting and/or receiving device, in particular a Bluetooth device. In extreme cases, the mechanical connecting device 1 can be reduced to the electric connecting device 2 and/or there is only a mechanical connection via a contact of permanent magnets 25, 26.

The at least one cable used in the connecting cord 7 should be highly flexible and/or capable of handling high currents.

The plug 10 and the plug socket 15 are ideally designed so that the connectors are safe to touch and protected from environmental influences.

Preferably, the storage devices 47 are charged with a charging power of 50 watts, while the voltage at a pushable transport cart 3 can be 5 V, 12 V or 24 V, for example (after voltage conversion if necessary).

For one operating mode, the pushable transport cart system 38 can enable a pushable transport cart 3 that is to be charged and is furthest away in line 37 from the charging station 32 to first be checked with regard to its charge state. If the storage device 47 is charged to at least a first threshold value (for example 70%), the charge flow control units 46 and the storage release device 48 are activated in such a way that this storage device 47 is charged. If, on the other hand, the charge state of the storage device 47 is greater than a second threshold value, which is less than the first threshold value (for example 30%), the charging station 32 charges the storage device 47 exclusively via the charge flow control units 46 and the storage release devices 48. If, on the other hand, the charge level of the storage device 47 falls below the second threshold value, the storage device 47 can be charged cumulatively by both the charging station 32 and the storage devices 47 of the pushable transport carts 3 arranged in line 37 in front of and/or behind it, which is a type of boost charging.

It is possible that the pushable transport cart 3 comprises an electric drive that replaces or supports a manual movement of the pushable transport cart 3. In this case, the drive system for one embodiment can also recuperate energy, which can then be supplied to the storage device 47.

Sensors can be connected to the connectors which comprise, for example
a load cell,
a position detection device (absolute like GPS; relative),
a temperature sensor for detecting whether the pushable transport cart 3 is located in a specific area of a supermarket, in particular a refrigerated area,
an acceleration sensor for detecting whether the pushable transport cart 3 is currently moving or stationary and how long it has been in a specific area of a supermarket and/or for detecting damaging operation of the push transport cart or even vandalism and/or for detecting a bumpy ride over a rough floor or in the area of tiles for indirect detection of an area in which the pushable transport cart 3 is being moved,
a brightness sensor to differentiate between day and night or to differentiate between shopping market areas with different brightness levels or to control the brightness of a display depending on the ambient brightness,
a camera, a scanner, an RFID transmitting and/or receiving device or a scanner for a barcode or QR code and/or
a microphone.

In this case, the connectors for transmitting data and the data processing unit 57 can be arranged for processing and transmitting corresponding signals and data.

The pushable transport carts 3 can comprise displays, which can be any optical display, a red-yellow-green traffic light system or similar.

Furthermore, the pushable transport cart can comprise 3 control units, which can be a smartphone, switches, a keyboard, a touchscreen, a voice control, rotary controls, etc., for example.

The pushable transport cart 3 can have a locking system or anti-theft system by means of which a wheel of the pushable transport cart 3 can be fixed or the securing chain 8 can be fixed.

It is also possible that the pushable transport cart system 38 has a latch in the area of the stockage station 33, which can be used to prevent the removal of push transport carts 3. In this case, a locking mechanism can be provided by a latch of the pushable transport cart 3 that is actuated by the pushable transport cart 3 itself. Alternatively or cumulatively, a latch of the stockage station 33 can interact with the pushable transport cart 3.

It is possible that a charging and stockage station 32, 33 enables two lines 37 of pushable transport carts 3 arranged next to each other, each of which can then be charged via an assigned charging station. Depending on the charge status, the pushable transport cart 3 can then be preferentially loaded in one of the two lines. In such a case, it is also possible for a user to be shown from which of the lines at the charging and stockage station 32, 33 a customer should remove a pushable transport cart 3. In particular, these are pushable transport carts 3 from line 37, comprising a higher loading status. This can be indicated to the customer on a central display of the charging and stockage station 32, 33 and/or on a display of the pushable transport cart 3.

It is possible that charging takes place exclusively via the connecting cord 7 of the pushable transport cart 3 or only partially, so that the circuit for charging requires both the establishment of the electric connection via the connecting cord 7 and additional contacting in another contact area of the pushable transport cart 3 or with a charging bar of the stockage station. This additional contact point can, for example, be arranged in the area of a shopping basket or a shopping cart chassis 4.

Data is transmitted using a serial protocol, for example.

A USP plug and/or a CAN bus can also be used.

It is possible that the data is transmitted in encrypted form.

It is possible that a separate line and assigned connectors are available for data transmission. However, it is also possible for data to be transmitted via the charging power line by modulating the charging voltage and/or the charging current.

Many variations and modifications may be made to the preferred embodiments of the invention without departing substantially from the spirit and principles of the invention. All such modifications and variations are intended to be included herein within the scope of the present invention, as defined by the following claims.

We claim:

1. A pushable transport cart comprising
at least one electric and/or electronic device,
an electric storage device, which is connected to the electric and/or electronic device for supplying electric power, and
a mechanical connecting device, by which the pushable transport cart can be mechanically connected to another pushable transport cart and/or a stockage and/or charging station, wherein
the mechanical connecting device and an electric connecting device are combined and
the mechanical connecting device and the electric connecting device are configured in such a way that when the mechanical connecting device of one pushable transport cart is mechanically connected to the mechanical connecting device of the other pushable transport cart or the stockage and/or charging station, at least one electric connection is created between the electric connecting device of the pushable transport cart and the electric connecting device of the other pushable transport cart or of the stockage and/or charging station, the electric connection being configured for at least one of an electric power exchange, a signal exchange or a data exchange,
a further electric connecting device is provided at a distance from the electric connecting device and the mechanical connecting device,
wherein the electric connecting device and the further electric connecting device form at least one electric circuit, wherein the electric circuit comprises a feed line, which is provided by the electric connecting device and leads from the stockage and/or charging station or the other pushable transport cart to the pushable transport cart, and a return line, which is provided by the further electric connecting device and leads back from the pushable transport cart to the stockage and/or charging station or to the other pushable transport cart, wherein the electric circuit is only closed when both the electric connecting device and the further electric connecting device establish a connection to the stockage and/or charging station or to the other pushable transport cart.

2. The pushable transport cart of claim 1, wherein the mechanical connecting device comprises a securing chain.

3. The pushable transport cart of claim 1, wherein the mechanical connecting device comprises a plug with an electrically conductive plug-in tongue and a plug socket into which a plug-in tongue of an adjacent pushable transport cart can be plugged, wherein
the plug socket comprises an elastic or elastically supported electric plug contact element which forms an electric contact with a plug-in tongue which is inserted into the plug socket, and/or
the plug-in tongue comprises a snap-in or interlocking surface which interacts with a snap-in or interlocking element of a plug socket of the other pushable transport cart or of the stockage and/or charging station for snap-in or interlocking.

4. The pushable transport cart of claim 1, wherein the electric connecting device comprises at least one of
redundant connectors, connector bars or interfaces, each of which being designed for being usable in different assembly orientations of the mechanical connecting device or
a plug and/or a plug socket, wherein the plug or the plug socket comprises an electric plug contact element which is elastic in a direction of insertion of the plug into the plug socket or is elastically supported.

5. The pushable transport cart of claim 1, wherein the mechanical connecting device comprises a permanent magnet.

6. The pushable transport cart of claim 1, wherein the further electric connecting device forms an electric contact
when a pushable transport cart and an adjacent pushable transport cart are pushed into one another or
forms an electric contact when the pushable transport cart is pushed into the stockage and/or charging station.

7. The pushable transport cart of claim 1, wherein the further electric connecting device comprises at least one of
connectors for an electric power supply,
at least one connector for detecting a charging station,
at least one additional connector,
at least one connector for signal transmission or
at least one connector for data transmission.

8. The pushable transport cart of claim 1, wherein a storage release device is provided, which
in a release position, connects the storage device to the electric connecting device in order to enable a charging status of the storage device to be changed via the electric connecting device, and
in a disconnected position, electrically disconnects the storage device from the electric connecting device.

9. The pushable transport cart of claim 1 comprising
a plug and a plug socket and
a charge flow control unit,
wherein the charge flow control unit is connected between the plug and the plug socket and
the charge flow control unit in a pass-through mode of operation connects the plug or the plug socket to the storage device and connects the plug to the plug socket, but disconnects the storage device from the plug or the plug socket and
the charge flow control unit in a charging operating mode disconnects the plug from the plug socket, but ensures the connection of the storage device to the plug or the plug socket.

10. The pushable transport cart of claim 1 comprising at least one of
a direction setting current flow element which is interposed between a plug and a plug socket,
a current sensor or switch,
an AC/DC voltage converter,
a charging device for a portable electronic device of a customer that can be connected to a main electrical line,
a voltage transformer that changes a voltage level,
a wireless transmitting and/or receiving device configured for a communication of the pushable transport cart or the stockage and/or charging station with a portable, network-compatible electronic device of a customer,
a flexible connecting cord which is a part of the electric connecting device and is connected in one end region to a plug or a plug socket,
an optical detection device which is integrated into the mechanical connecting device and a specific identifier.

11. A pushable transport cart system comprising a plurality of interconnected pushable transport carts, the pushable transport carts each comprising
at least one electric and/or electronic device,
an electric storage device, which is connected to the electric and/or electronic device for supplying electric power, and
a mechanical connecting device, by which the pushable transport cart can be mechanically connected to another pushable transport cart and/or a stockage and/or charging station, wherein
the mechanical connecting device and an electric connecting device are combined and
the mechanical connecting device and the electric connecting device are configured in such a way that when the mechanical connecting device of one pushable transport cart is mechanically connected to the mechanical connecting device of the other pushable transport cart or the stockage and/or charging station, at least one electric connection is created between the electric connecting device of the pushable transport cart and the electric connecting device of the other pushable transport cart or of the stockage and/or charging station, the electric connection being configured for at least one of an electric power exchange, a signal exchange or a data exchange, and
a further electric connecting device is provided at a distance from the electric connecting device and the mechanical connecting device,
wherein the electric connecting device and the further electric connecting device form at least one electric circuit, wherein the electric circuit comprises a feed line, which is provided by the electric connecting device and leads from the stockage and/or charging station or the other pushable transport cart to the pushable transport cart, and a return line, which is provided by the further electric connecting device and leads back from the pushable transport cart to the stockage and/or charging station or to the other pushable transport cart, wherein the electric circuit is only closed when both the electric connecting device and the further electric connecting device establish a connection to the stockage and/or charging station or to the other pushable transport cart.

12. The pushable transport cart system of claim 11 comprising control logic which recognizes when the pushable transport cart is mechanically and/or electrically connected to an adjacent pushable transport cart.

13. The pushable transport cart system of claim 11 comprising control logic which detects or determines a number of pushable transport carts connected in a line to each other or to a stockage and/or charging station.

14. The pushable transport cart system of claim 11 comprising control logic which controls an exchange of electric energy between pushable transport carts which are connected to each other but not to a stockage and/or charging station.

15. The pushable transport cart system of claim 11 comprising control logic which ensures a charge flow management wherein in a pass-through operating mode, a plug is connected to a plug socket, but the storage device is disconnected from the plug or the plug socket and in a charging operating mode, the plug is disconnected from the plug socket, but the storage device is connected to the plug or the plug socket.

16. The pushable transport cart system of claim 11 comprising control logic which ensures a charge flow management which takes into account a specific charging quantity for a supermarket or a baggage transportation area.

17. The pushable transport cart system of claim 11 comprising control logic which ensures a charge flow management in which a specific demand parameter for at least one of
a supermarket or a baggage transportation area or
for a time and/or a day of a week is taken into account, the specific demand parameter correlating with an expected demand of the pushable transport carts used by customers per time unit.

18. A pushable transport cart system of claim 11 comprising control logic which ensures a charge flow management, in which, in the case of a line of pushable transport carts connected to the stockage and/or charging station, the pushable transport cart furthest away from the stockage and/or charging station is charged first until a threshold value of a charging status is reached, and then the pushable transport carts adjacent in a direction of the stockage and/or charging station is successively charged.

19. The pushable transport cart system of claim 11 comprising control logic which ensures a charge flow management, in which a storage device of a pushable transport cart is charged from a storage device of at least one other pushable transport cart.

20. The pushable transport cart system of claim 11 comprising control logic which detects a separation of at least one of
a pushable transport cart from another pushable transport cart and/or from a stockage and/or charging station,
the mechanical connecting devices of the pushable transport carts and/or the stockage and/or charging station or
the electric connecting devices of the pushable transport carts and/or the stockage and/or charging station.

21. The pushable transport cart system of claim 20 comprising control logic which, in the event of a detected separation performs at least one of the following
activation of a display of a pushable transport cart,
activation of a wireless transmitting and/or receiving device,
activation of a tracking function for tracking a location of the pushable transport cart,
activation of a product scanner or
activation of a purchase processing software.

22. The pushable transport cart system of claim 20 comprising control logic which, in the event of a detected separation executes a self-test of the pushable transport cart, in which a charging status of the storage device is checked and/or an electric signal and/or a sensor signal is checked.

23. The pushable transport cart system of claim 11 comprising control logic which detects a connection at least one of
a pushable transport cart with another pushable transport cart and/or with a stockage and/or charging station,
the mechanical connecting devices of the pushable transport carts and/or the stockage and/or charging station or
the electric connecting devices of the pushable transport carts and/or the stockage and/or charging station.

24. The pushable transport cart system of claim 23 comprising control logic which, when a connection is detected, deactivates at least one of a display of a pushable transport cart, a wireless transmitting and/or receiving device, a tracking function for tracking a location of the pushable transport cart, a product scanner or a purchase processing software.

25. The pushable transport cart system of claim 23 comprising control logic which, on the basis of a signal from a sensor detects whether a shopping product or an object belonging to a user is still on the pushable transport cart and in this case provides the user with information that a product or an object belonging to the user is still on the pushable transport cart.

26. A pushable transport cart comprising
at least one electric and/or electronic device,
an electric storage device, which is connected to the electric and/or electronic device for supplying electric power, and
a mechanical connecting device, by which the pushable transport cart can be mechanically connected to another pushable transport cart and/or a stockage and/or charging station, wherein
the mechanical connecting device and an electric connecting device are combined and
the mechanical connecting device and the electric connecting device are configured in such a way that when the mechanical connecting device of one pushable transport cart is mechanically connected to the mechanical connecting device of the other pushable transport cart or the stockage and/or charging station, at least one electric connection is created between the electric connecting device of the pushable transport cart and the electric connecting device of the other pushable transport cart or of the stockage and/or charging station, the electric connection being configured for at least one of an electric power exchange, a signal exchange or a data exchange,
a further electric connecting device is provided at a distance from the electric connecting device and the mechanical connecting device,
wherein the electric connecting device and the further electric connecting device form at least one electric circuit, wherein the electric circuit comprises a feed line, which is provided by the electric connecting device and leads from the stockage and/or charging station or the other pushable transport cart to the pushable transport cart, and a return line, which is provided by the further electric connecting device and leads back from the pushable transport cart to the stockage and/or charging station or to the other pushable transport cart, wherein the electric circuit becomes closed in response to both the electric connecting device and the further electric connecting device establishing a connection to the stockage and/or charging station or to the other pushable transport cart.
